(19) United States
(12) Patent Application Publication
(10) Pub. No.: US 2005/0262297 A1
(43) Pub. Date: Nov. 24, 2005

(54) Disk drive connected to host system via memory interface circuit, and interface connecting method

(75) Inventors: Yutaka Arakawa, Ome-shi (JP); Tadaaki Kinoshita, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/102,734

(22) Filed: Apr. 11, 2005

(30) Foreign Application Priority Data
May 18, 2004 (JP) 2004-147876

(51) Int. Cl. G06F 12/00

(52) U.S. Cl. 711/112

(57) ABSTRACT

A disk drive comprises a disk control unit conforming to versatile parallel interfaces. The disk control unit has a register file that includes a plurality of registers a host system can access. The disk drive further comprises an input/output (IO) interface circuit connected to the disk control unit via a parallel interface. The IO interface circuit is connectable to a memory interface circuit incorporated in the host system. The IO interface circuit utilizes a protocol for parallel interfaces to communicate with the disk control unit, and utilizes a protocol for serial interfaces to communicate with the memory interface circuit.

### CROSS-REFERENCE TO RELATED APPLICATIONS

This application is based upon and claims the benefit of priority from prior Japanese Patent Application No. 2004-147876, filed May 18, 2004, the entire contents of which are incorporated herein by reference.

### BACKGROUND OF THE INVENTION

1. Field of the Invention

The present invention relates to a disk drive connectable to a host system, and more particularly to a disk drive to be connected to a host system via an existing memory interface circuit that also serves as an input/output (IO) serial interface circuit, and an interface connecting method.

2. Description of the Related Art

In general, disk drives represented by hard disk drives (HDDs) are used as storage apparatuses for such electronic devices as personal computers. Electronic devices utilizing such disk drives are called host systems. In general, a host system and disk drive have their respective versatile parallel interfaces such as AT Attachment (ATA) interfaces. The disk drive has a register file that includes registers. The host system operates the registers in the register file, using a register operation command. By this operation, the host system writes, to the register file, a command (command code) and various parameters necessary to execute the command. The host system performs execution of a command and transmission/reception of data by operating registers, i.e., by accessing registers in the disk drive.

Serial interfaces called serial ATA interfaces have recently been developed as interfaces for increasing the rate of data transfer between a host system and disk drive. The serial ATA interfaces (serial interfaces) have physical specifications different from those of conventional ATA interfaces (i.e., parallel ATA interfaces or parallel interfaces). Accordingly, to connect a host system to a disk drive by a serial ATA interface, it is necessary to provide respective serial ATA interface circuits for the host system and disk drive.

Further, an increasing number of host systems have come to incorporate card slots. A memory card equipped with a flash memory can be mounted in a card slot. With a memory card inserted in a card slot, a host system can perform high-rate serial transfer of data from and to the memory card. Jpn. Pat. Appln. KOKAI Publication No. 2003-69931 has proposed a technique for enabling a disk drive (data storing drive) of a large capacity to be connected to the memory interface circuit of a host system through a card slot formed in the host system. However, to connect the disk drive to the memory interface circuit of the host system, the disk drive must have a serial interface circuit that conforms to the interface standards for memory cards.

### BRIEF SUMMARY OF THE INVENTION

In accordance with an embodiment of the invention, a disk drive used by a host system is provided. The host system includes a memory interface circuit which also serves as a serial interface circuit for connecting the host system to an input/output device conforming to a serial interface. The disk drive comprises a disk control unit conforming to a parallel interface, and an input/output interface circuit connected to the disk control unit via the parallel interface. The disk control unit includes a register file used to hold a command code and parameters, and a main controller. The register file includes a plurality of registers equivalent to registers incorporated in an existing disk drive conforming to the parallel interface, the host system being accessible to the plurality of registers of the register file. The input/output interface circuit is connectable to the memory interface circuit of the host system. The input/output interface circuit utilizes a protocol for the parallel interface to communicate with the disk control unit, and utilizes a protocol for the serial interface to communicate with the memory interface circuit of the host system. The main controller controls the registers of the register file in accordance with a series of register control commands and acquires a command code and parameters from the register file, when the host system sends the series of register control commands to the disk drive via the memory interface circuit of the host system, and the series of register control commands are transferred from the input/output interface circuit to the disk control unit. The command code and parameters are designated by the series of register control commands. The command code is to be executed in the disk drive, the parameters are necessary to execute the command code.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram illustrating the configuration of a system with a hard disk drive (HDD) 10 according to an embodiment of the invention;

FIG. 2 is a view illustrating a structural example of the register file 112b appearing in FIG. 1;

FIG. 3 is a flowchart useful in explaining the procedure of processing performed in the embodiment for discriminating the type of a device connected to the host 20 appearing in FIG. 1; and

FIGS. 4A to 4C are flowcharts useful in explaining the procedure of processing performed in the embodiment for reading data from the HDD 10.

### DETAILED DESCRIPTION OF THE INVENTION

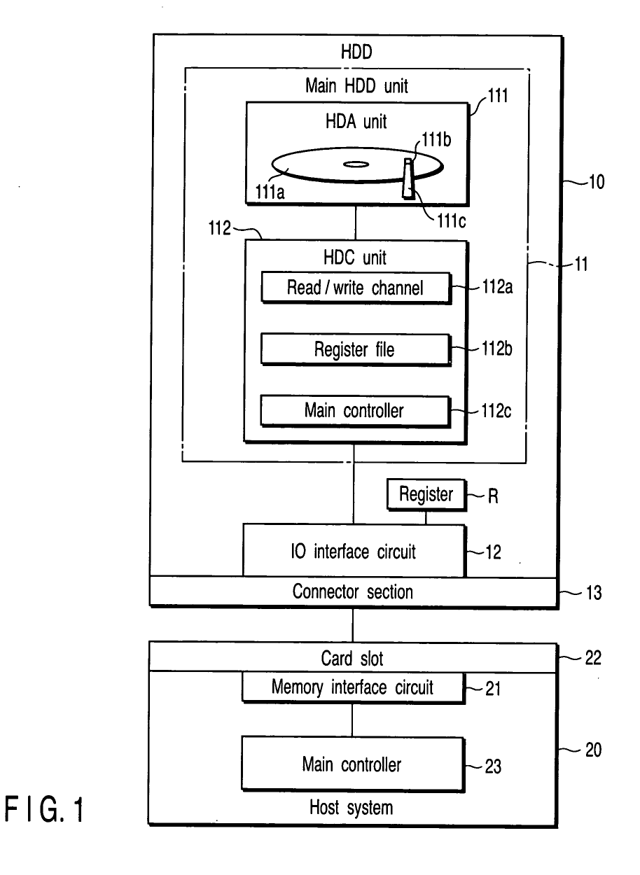

An embodiment in which the invention is applied to a hard disk drive will be described in detail with reference to the accompanying drawings. FIG. 1 is a block diagram illustrating the configuration of a system with a hard disk drive (HDD) 10 according to the embodiment of the invention. The HDD 10 shown in FIG. 1 is, for example, a card-type HDD of the same shape as a memory card, and is a 0.85-inch HDD. The HDD 10 is used, connected to a host 20. The host 20 uses the HDD 10 as its storage. The host 20 is an electronic device represented by a personal computer, portable terminal, mobile phone, etc. The host 20 comprises a memory interface circuit 21, card slot 22 and main controller 23.

The memory interface circuit 21 serves as a memory interface for connecting the main controller 23 of the host 20 to a memory card inserted in the card slot. The memory card is, for example, a secure digital (SD) memory card. The memory interface circuit 21 can be connected to a card other than the memory card. It is sufficient if the card conforms to the electrical and mechanical specifications of the memory interface. For example, the memory interface circuit 21 is also connectable to an IO card with an input/output (IO) device conforming to serial interfaces. In other words, the memory interface circuit 21 can be also used as a serial interface circuit (IO serial interface circuit) to be connected to the IO device conforming to serial interfaces. The HDD (card-type HDD) 10 is one of IO cards represented by a secure digital input/output card (SDIO card).

Host systems that can use a memory interface as a serial interface (IO serial interface) are known. These host systems include a host system that can use a card slot conforming to SD memory interfaces as a card slot conforming to serial (SDIO serial) interfaces. An IO card (IO device) connectable to this host system generally has a register file. Assume here that the host system uses the memory interface as a serial (SDIO serial) interface, and that the host system is connected to an IO device by the serial interface (via a card slot conforming to serial interfaces). The host system controls transfer of data from and to the IO device. Specifically, the host system controls data transfer in accordance with an IO device control program, by operating the register file in the IO device.

As mentioned above, when the host system controls data transfer from and to the IO device, using the serial interface, it must operate the register file. The same can be said of the case where the host system receives and transfers data from and to an HDD having a parallel interface (parallel ATA interface). The embodiment is characterized in that utilizing this point, the HDD 10 is made connectable to the memory interface of the host system 20, i.e., an existing memory interface that is also used as a serial interface (IO serial interface).

The card slot 22 is used to mount therein a card (memory card or IO card) conforming to the electrical and mechanical specifications of the memory interface (serial interface), so that the card is connectable to the memory interface circuit 21. Assume here that the HDD (card-type HDD) 10 is inserted in the card slot 22 of the host system 20. A connector conforming to the electrical and mechanical specifications of the memory interface and connected to an IO device by an interface cable can also be mounted in the card slot 22. Accordingly, even if the HDD 10 is not of a card type, it can be connected to the memory interface circuit 21 of the host system 20 when it is connected to a card connector via an interface cable. Further, the card slot 22 is not always necessary. For instance, if the host system 20 is a portable small-size electronic device such as a mobile phone, the HDD 10 may be connected to the memory interface circuit 21 by a cable or printed wiring in the casing of the host system 20.

The main controller 23 controls each element of the host system 20, and a peripheral device connected to the host system 20. When the main controller 23 is connected to the HDD 10 via the memory interface circuit 21, it controls the HDD 10 in accordance with an HDD control program. In this case, the main controller 23 treats the HDD 10 as an HDD having a versatile parallel interface (parallel ATA interface).

The HDD 10 comprises a main HDD unit 11, input/output (IO) interface circuit 12 and connector unit 13. The main HDD unit 11 is equivalent to a conventional HDD for performing parallel data transfer using a parallel interface (e.g., an ATA interface), i.e., an HDD having a parallel interface. The main HDD unit 11 mainly comprises a hard disk assembly (HDA) unit 111 and hard disk control (HDC) unit 112.

The HDA unit 111 mainly includes mechanical sections incorporated in the HDD 10. Specifically, the HDA unit 11 includes a disk (magnetic disk) 111a, head (magnetic head) 111b and actuator 111c. The disk 111a is used as a recording medium for magnetically recording data. The head 111b is used to read and write data from and to the disk 111a. The actuator 111c supports the head 111b so that the head 111b is radially movable over the disk 111a. FIG. 1 does not show a spindle motor for spinning the disk 111a, voice coil motor for driving the actuator 111c, etc.

The HDC unit 112 conforms to versatile parallel interfaces. The parallel interface is, for example, an ATA interface (parallel ATA interface) widely used in the field of HDDs. The HDC 112 includes electric circuit sections. Specifically, the HDC unit 112 includes a read/write channel 112a, register file 112b and main controller 112c. The read/write channel 112a is a signal-processing device for executing various types of processing, such as analog-to-digital conversion of a signal indicating data read from the disk 111a by the head 111b, encoding of write data, and decoding of read data.

The register file 112b is formed of a plurality of registers. The register file 112b is used to write therein a command (command code) and various parameters needed for executing the command, when the host system 20 utilizes the HDD 10. Conventional (existing) HDDs conforming to parallel interfaces (ATA interfaces) also have a register file equivalent to the register file 112b. Assume that each register file of the conventional HDDs is formed of m registers R_{0′}, R_{1′}, R_{2′}, . . . R_{m-1′}. The size of register R_{0′} is 16 bits (2 bytes), and the size of the registers R_{1′}, R_{2′}, . . . R_{m-1′} is 8 bits (1 byte).

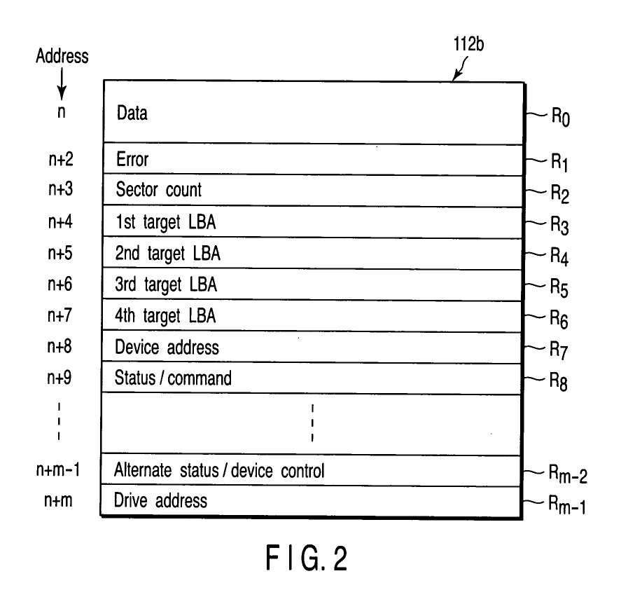

FIG. 2 shows a structure example of the register file 112b. In this example, the register file 112b is formed of m registers R₀, R₁, R₂, . . . Rₘ₋₁, to which addresses n, n+2, n+3, . . . , n+m are assigned, respectively. The roles of the registers R₀, R₁, R₂, . . . Rₘ₋₁ are equivalent to those of the registers R_{0′}, R_{1′}, R_{2′}, . . . R_{m-1′} of the conventional HDD. The size of the register R₀ is 16 bits (2 bytes) like the register R_{0′}, and the size of the registers R₁, R₂, . . . Rₘ₋₁ is 8 bits (1 byte) like the registers R_{1′}, R_{2′}, . . . R_{m-1′}. Respective addresses are assigned to the registers R_{0′}, R_{1′}, R_{2′}, . . . R_{m-1′}. The addresses of the registers R_{1′}, R_{2′}, . . . R_{m-1′} relative to the register R₀ are 2, 3, . . . , m, respectively. In the embodiment, as aforementioned, addresses n, n+2, n+3, n+m are assigned to the registers R₀, R₁, R₂, . . . Rₘ₋₁. By virtue of this address assignment, the addresses of the registers R₁, R₂, . . . Rₘ₋₁ relative to the register R₀ are made to correspond to those of the registers R_{1′}, R_{2′}, . . . Rₘ₋₁ relative to the register R_{0′}. In this case, the main controller 112c can treat the registers R₀, R₁, R₂, . . . Rₘ₋₁ in the same manner as in the conventional HDD by recognizing the address n of the register R₀, i.e., the offset address n. As is apparent, the relative address of each of the registers R₀ and R_{0′} as reference registers is zero.

A description will now be given of essential ones of the registers R₀ to Rₘ₋₁. The register R₀ is, for example, a data register. The register R₀ is used to hold read data during reading and write data during writing in units of 16 bits (2 bytes). The register R₁ is an error register. When an error occurs during reading or writing, the register R₁ is used to hold detailed information concerning the error (error information). The content of the register R₁ becomes valid if an error bit ERR, described later, included in status information held in each of the register (status register) R₈ and register (alternate register) Rₘ₋₂ is “1”. The host system 20 recognizes the register R₁ as a read register dedicated to reading.

The register R₂ is a sector count register. The register R₂ is used to hold the number of sectors of data to be read or written. The registers R₃, R₄, R₅ and R₆ are first, second, third and fourth target logic-block-address (LBA) registers, respectively. The target LBA registers R₃, R₄, R₅ and R₆ are used to hold respective bits included in, for example, a 28-bit target LBA (target logic-block-address) indicating a leading sector as a target of reading or writing. More specifically, the target LBA registers R₃, R₄, R₅ and R₆ hold bits 7 to 0 (first target LBA [7-0]), bits 15 to 8 (second target LBA [15-8]), bits 23 to 16 (third target LBA [23-16]), and bits 27 to 24 (fourth target LBA [27-24]), respectively, included in the 28-BIT target LBA.

The register R₈ is used as a command register for holding a command code designated by the host system 20. The host system 20 recognizes the command register R₈ as a write register dedicated to writing. The register R₈ is also used as a status register for holding information concerning the status of the HDD 10 to be reported to the host system 20. The host system 20 recognizes the status register R₈ as a read register dedicated to reading. In the embodiment, after the register R₈ is used as a command register and a command code is written to the register R₈, the register R₈ is switched to be used as a status register. The status information held by the register (status register) R₈ includes a data request bit DRQ, busy bit BSY and error bit ERR. The bit DRQ indicates whether data transfer is possible (DRQ=1) or not (DRQ=0) during the execution of a command requiring data transfer. The bit BSY indicates whether the HDD 10 is operating (BSY=1) or not (BSY=0). The bit BSY is set to “1” after a command code is written to the register R₈ and the register R₈ is switched from a command register to a status register, and kept at “1” until the operation designated by the command code is finished. However, when a request for data transfer based on the command requiring data transfer is issued (DRQ=1), the bit BSY is set to “0”. After the content (status information) of the register R₈ is read, the register R₈ is reset. The bit ERR indicates whether an error has occurred during the execution of the command supplied from the host system 20 (ERR=1), or not (ERR=0).

The register Rₘ₋₂ is used as an alternate status register for holding the same status information as the status register R₈. The alternate status register Rₘ₋₂ differs from the status register R₈ in that the register Rₘ₋₂ is not reset even if its content is read. The alternate status register Rₘ₋₂ is recognized as a read register by the host system 20. The register Rₘ₋₂ is also used as a device control register recognized as a write register by the host system 20. The device control register Rₘ₋₂ is used by the host system 20 when the system controls a reset signal and interruption signal for the HDD 10.

Referring again to FIG. 1, the main controller 112c performs register control on the register file 112b in accordance with a series of register control commands. This register control is performed when a series of register control commands, sent by the host system 20 to the HDD 10 via the memory interface circuit 21, reach the HDC unit 112 via the IO interface circuit 12. By the register control, the main controller 112c acquires a command code and parameters from the register file. The command code and parameters are designated by the series of register control commands. The command code is to be executed in the HDD 10, the parameters are necessary to execute the command code. Using these parameters, the main controller 112c executes the command code.

The IO interface circuit 12 is, for example, an SDIO interface circuit. The IO interface circuit 12 is connected to the HDC unit 112 of the main HDD unit 11 via a parallel interface. Further, the IO interface circuit 12 is connectable to the memory interface circuit 21 of the host system 20. The IO interface circuit 12 utilizes the protocol for parallel interfaces to communicate with the HDC unit 112, and the protocol for serial interfaces to communicate with the memory interface circuit 21 of the host system 20. The IO interface circuit 12 has a serial-to-parallel conversion function for converting, into parallel data, serial data transferred from the host system 20 via the memory interface circuit 21 and connector unit 13, and has a parallel-to-serial conversion function for converting, into serial data, parallel data transferred from the HDC unit 112.

The IO interface circuit 12 is connected to a register R unique to the IO interface (DSIO interface). The register R is used to prestore information (device information) concerning a device (HDD 10 in this embodiment) that incorporates the IO interface circuit 12. The device information held by the register R contains the type of the device (HDD 10), and the offset address n (i.e., the address n of the leading register R₀) of each register R₀ to Rₘ₋₁ in the register file 112b.

A description will now be given of the following operations performed in the above-described embodiment:
(1) The operation of determining the type of a device (connected device) connected to the memory interface circuit 21 of the host system 20 via the card slot 22;
(2) The operation of reading data from the HDD 10 by the host system 20; and
(3) The operation of writing data to the HDD 10 by the host system 20

Re: (1) Determination of the type of a connected device:

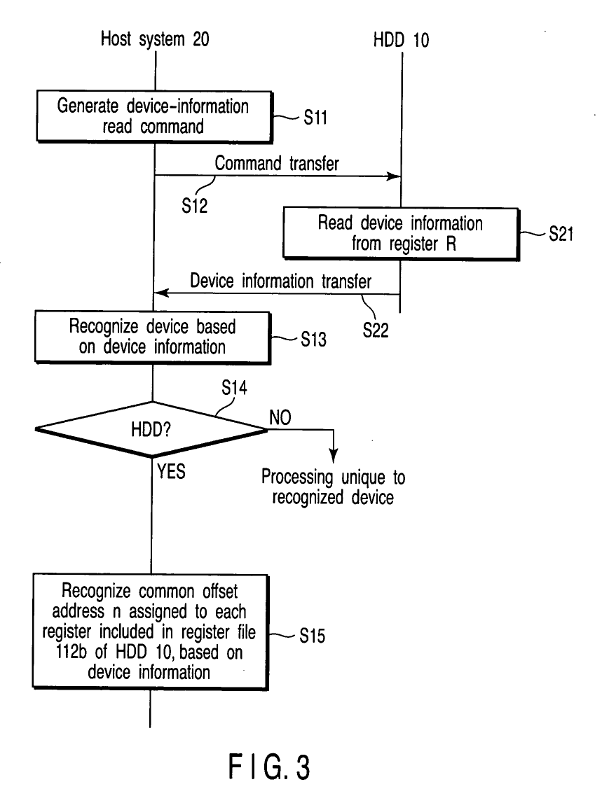

Referring first to the flowchart of FIG. 3, the operation of determining the type of a connected device by the host system 20 will be described. The interface circuit (conforming to the memory interface) of the device mounted in the card slot 22 of the host system 20 is connected to the device information register R, like the IO interface circuit 12 of the HDD 10 shown in FIG. 1. The register R holds device information concerning the device. If the device has an interface circuit conforming to the memory interface, the address of the register R is a particular common address regardless of the type of the device. Further, the memory interface has a command (CMD) line. The main controller 23 of the host system 20 is configured to be able to operate, via the CMD line, each register in the device connected to the memory interface circuit 21. Specifically, upon activation of the host system 20, the main controller 23 generates a register control command (device-information read command) for reading the content (device information) of the device information register R in the device connected to the memory interface circuit 21 (step S11). This command includes a command code for reading register data, and information for recognizing the device information register R as a reading target, e.g., the particular address (particular register address). The particular register address is an address (IO address) in the input/output space of the host system 20, which is assigned to the register R. The register control command (device-information read command) generated by the main controller 23 is sent to the memory interface circuit 21 by parallel transfer.

The memory interface circuit 21 of the host system 20 converts, into serial data (a serial register control command), the register control command (device-information read command) parallel-transferred from the main controller 23. After that, the memory interface circuit 21 transfers the serial register control command to the device (in this embodiment, the HDD 10) inserted in the card slot 22 in accordance with the protocol for the memory interface (serial interface) (step S12). The memory interface (serial interface) uses the CMD (command) line for transfer of the command.

The device inserted in the card slot 22 reads device information from the device information register R in accordance with the register control command (device-information read command) transferred through the CMD line. In the embodiment in which the device inserted in the card slot 22 is the HDD 10, the device information concerning the HDD 10 is read from the register R by the IO interface circuit 12 (step S21). The device information is converted into serial data by the IO interface circuit 12. The device information as serial data is transferred by the IO interface circuit 12 to the host system 20 via the CMD line in response to the register control command (device-information read command) (step S22). In the host system 20, the device information is converted into parallel data by the memory interface circuit 21 and sent to the main controller 23.

Upon receiving the device information, the main controller 23 recognizes the device inserted in the card slot 22, i.e., the device connected to the memory interface circuit 21 (step S13). If it is determined at step S14 that the device is an HDD (HDD 10), the main controller 23 detects, from the device information, the address n of the leading register R₀ contained in the register file 112b of the HDD 10, i.e., the common offset address n of each register R₀ to Rₘ₋₁ contained in the register file 112b (step S15). Thereafter, the main controller 23 treats (recognizes) the HDD 10 as an HDD having a parallel interface (ATA interface) in accordance with the control program for HDDs. Thus, the main controller 23 controls data transfer from and to the HDD 10 by operating the register file 112b in the HDD 10.

Re: (2) Reading of data from the HDD 10:

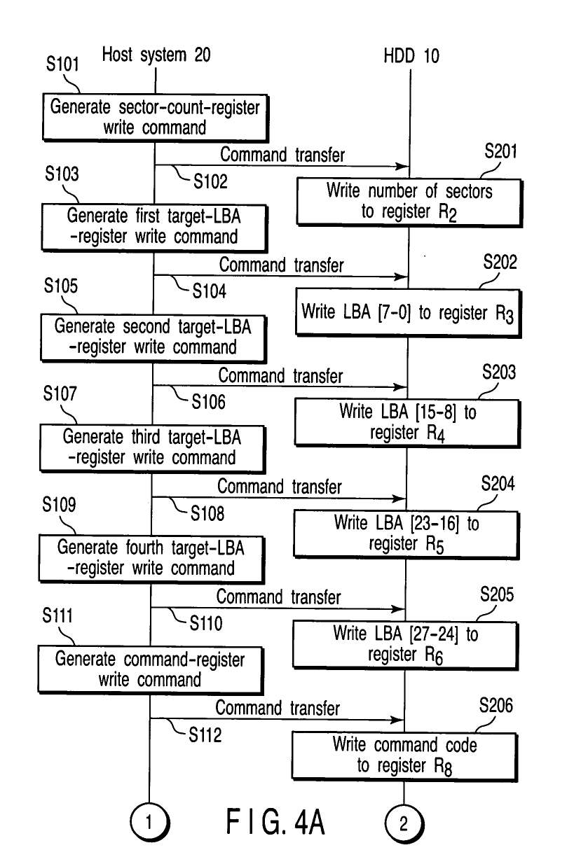

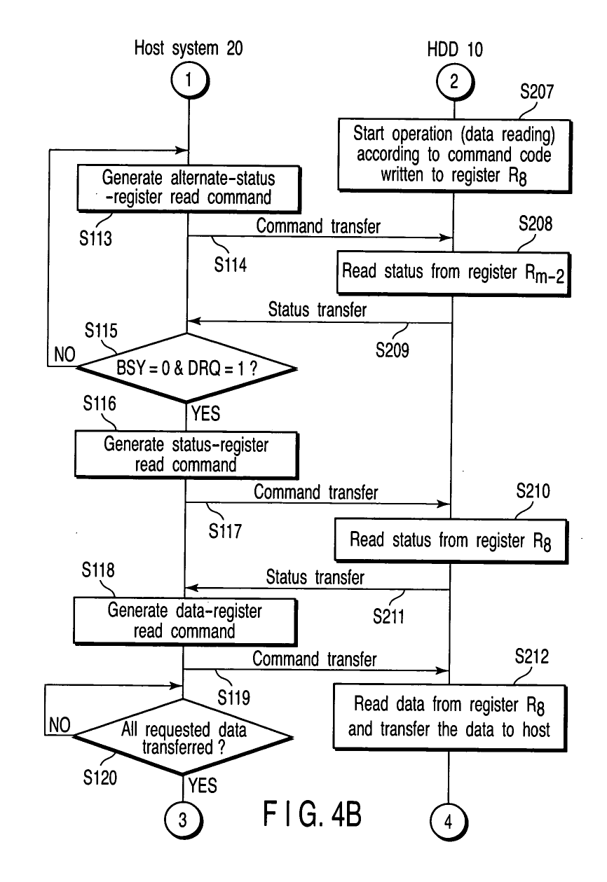

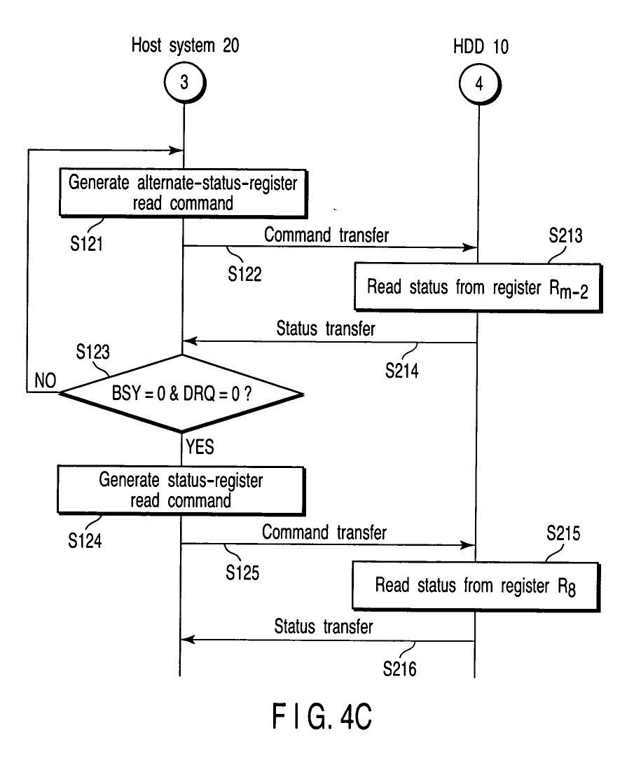

Referring then to the flowchart of FIGS. 4A to 4C, the operation of reading data from the HDD 10 by the host system 20 will be described. The main controller 23 of the host system 20 functions in the following manner, assuming that the HDD 10 has a parallel interface (ATA interface). Firstly, the main controller 23 generates a register control command (sector-count-register write command) for writing the number of sectors to the register R₂ of the register file 112b included in the HDC unit 112 of the HDD 10 (step S101). This command conforms to the standards for parallel interfaces (ATA interfaces). The command includes a command code (register control code) for register control, an address (register address) in an IO space assigned to the register to be controlled, and a parameter to be written (set) to the register. If the register control command is a sector-count-register write command as in the present case, the register address designates the sector count register R₂, and the parameter indicates the number of sectors. The register control command (sector-count-register write command) generated by the main controller 23 is parallel-transferred to the memory interface circuit 21.

The memory interface circuit 21 of the host system 20 converts, into serial data (a serial register control command), the register control command (sector-count-register write command) parallel-transferred from the main controller 23. The memory interface circuit 21 transfers the serial register control command to the HDD 10 via the card slot 22 in accordance with the protocol for the memory interface (serial interface) (step S102). The memory interface circuit 21 uses the CMD line for command transfer.

The IO interface circuit 12 of the HDD 10 receives the serial register control command transferred through the CMD line, converts it into a parallel register control command, and sends it to the main controller 112c of the main HDD unit 11 in accordance with the protocol for parallel interfaces.

The main controller 112c receives the register control command from the main controller 23 of the host system 20 via the IO interface circuit 12. The main controller 112c recognizes as if the IO interface circuit 12 is a host conforming to parallel interfaces (ATA interfaces). Therefore, upon receiving the register control command from the IO interface circuit 12, the main controller 112c performs register control in accordance with the register control command (step S201). In other words, the main controller 112c performs register control unique to parallel interfaces (ATA interfaces) for writing a parameter contained in the command to the register in the register file 112b designated by the register address contained in the register control command. The register control command executed here is the sector-count-register write command, and includes the register address designating the sector counter register R₂, and the parameter indicating the number of sectors. Accordingly, at step S201, by executing the register control command (sector-count-register write command), the number of sectors is written to the sector count register R₂ in the register file 112b.

In the same manner as the above, the main controller 23 of the host system 20 sequentially generates the first to fourth target-LBA-register write commands (steps S103, S105, S107 and S109). The first target-LBA-register write command is a register control command for writing the first target LBA [7-0] to the first target LBA register R₃. The second target-LBA-register write command is a register control command for writing the second target LBA [15-8] to the second target LBA register R₄. Similarly, the third target-LBA-register write command is a register control command for writing the third target LBA [23-16] to the third target LBA register R₅. Further, the fourth target-LBA-register write command is a register control command for writing the fourth target LBA [27-24] to the fourth target LBA register R₆. The first to fourth target-LBA-register write commands contain register addresses designating the registers R₃, R₄, R₅ and R₆, respectively, and parameters indicating the target LBAs [7-0], 15-8], [23-16] and [27-24], respectively. The memory interface circuit 21 sequentially converts the first to fourth target-LBA-register write commands into respective serial register control commands, and sequentially transfers the resultant commands to the HDD 10 (steps S104, S106, S108 and S110).

The main controller 112c of the HDD 10 sequentially receives the first to fourth target-LBA-register write commands from the IO interface circuit 12 of the HDD 10. In accordance with the received first to fourth target-LBA-register write commands (register control commands), the main controller 112c sequentially writes the target LBAs [7-0], [15-8], [23-16] and [27-24] to the registers R₃, R₄, R₅ and R₆, respectively (steps S202, S203, S204 and S205). As a result, the 28-bit target LBA [27-0] is dispersively stored in the registers R₃, R₄, R₅ and R₆.

Subsequently, the main controller 23 of the host system 20 generates a register control command (command-register write command) for writing, to the register R₈, a command code (for designating, for example, reading) to be executed by the HDD 10 (step S111). This command includes a register address for designating the command register R₈, and a command code. The command code is to be executed by the HDD 10 using the parameters that are already written to the register file 112b of the HDD 10 in accordance with the first to fourth target-LBA-register write commands. In this embodiment, this command code designates reading. The register control command (command-register write command) is converted into a serial register control command by the memory interface circuit 21 and transferred to the HDD 10 (step S112).

The main controller 112c of the HDD 10 receives the serial register control command (command-register write command) from the IO interface circuit 12 of the HDD 10. Subsequently, the main controller 112c writes, to the register R₈, the command code (for designating reading) included in the received command (step S206). As a result, the main controller 112c determines that the host system 20 has issued a command to the HDD 10, and starts to perform an operation according to the command code written in the command register R₈, i.e., an operation requested by the host system 20 (step S207). In this embodiment, a data read operation is started, in which data corresponding to the number of sectors indicated by the register R₂ is read from the portion of the disk 111a, starting at the position on the disk 111a designated by the target LBA [27-0] dispersively stored in the registers R₃, R₄, R₅ and R₆.

As described above, in the embodiment, the HDD 10 with the HDC unit 112 conforming to versatile parallel interfaces (ATA interfaces) can be connected by a serial interface to the existing memory interface circuit 21 incorporated in the host system 20, if the IO interface circuit 12 (minimum-scale circuit) is connected to the HDD 10 by a parallel interface. As a result, the host system 20 can control, using a register control command, the HDD 10 connected thereto by the memory interface circuit 21, in the same way as when controlling an HDD having a generally used parallel interface. In other words, the host system 20 can supply the HDD 10 with an operation command (command code) and parameters necessary to execute the command, via an existing memory interface. Moreover, in the embodiment, a relative address included in the addresses (i.e., the relative address and an offset address) assigned to each register R₀ to Rₘ₋₁ of the register file 112b is made to correspond to a relative address included in the addresses assigned to each register R₀, to Rₘ₋₁ of an existing HDD conforming to versatile parallel interfaces. This enables the host system 20 to issue a command to the HDD 10 and make the HDD 10 execute the command in the same procedure as in the case where the host system 20 is connected to the HDD 10 by a parallel interface (ATA interface). Accordingly, a control program designed for HDDs with conventional parallel interfaces can be used as a disk control program to be executed by the main controller 23 of the host system 20. Further, when a program designer newly designs a disk control program, they can utilize the way of designing a control program for HDDs with conventional parallel interfaces, which reduces the time and effort required for newly designing the program.

The main controller 112c of the HDD 10 switches the register R₈ from the command register R₈ to the status register R₈ when starting an operation (data reading in this embodiment) corresponding to the command code written to the register R₈. Subsequently, the main controller 112c writes status information including a busy bit BSY (BSY=1) to the status register R₈ and alternate status register Rₘ₋₂. Assume here that read data is written to the data register R₀ by data reading. At this time, the main controller 112c determines that data transfer requested by the host system 20 can be performed, thereby rewriting, to “0” and “1”, respectively, the busy bit BSY and data request bit DRQ included in the status information held in each of the status register R₈ and alternate status register Rₘ₋₂.

After the HDD 10 executes the command-register write command, the main controller 23 of the host system 20 generates a register control command (alternate-status-register read command) for reading status information from the alternate status register Rₘ₋₂ (step S113). The register control command (alternate-status-register read command) is converted into a serial register control command by the memory interface circuit 21, and transferred to the HDD 10 (step S114).

The main controller 112c of the HDD 10 receives the register control command (alternate-status-register read command) from the IO interface circuit 12 of the HDD 10. In accordance with this command, the main controller 112c reads the status information from the alternate status register Rₘ₋₂ (step S208). The main controller 112c sends the read status information to the IO interface circuit 12. The IO interface circuit 12 converts it into serial status information, and sends the serial status information to the host system 20 in accordance with the protocol for serial interface (step S209).

The main controller 23 of the host system 20 refers to the bits BSY and DRQ included in the status information, thereby determining whether BSY=1 and DRQ=0 (step S115). The main controller 23 repeats the execution of step S113 until it is confirmed that BSY=1 and DRQ=0 (step S115), i.e., until the HDD 10 becomes able to perform data transfer requested. Upon confirming that BSY=1 and DRQ=0, the main controller 23 generates a register control command (status-register read command) for reading new status information from the status register R₈ (step S116). The status-register read command is serial-transferred to the HDD 10 (step S117). As a result, in the HDD 10, status information is read from the status register R₈ in the same manner as in the case of the alternate-status-register read command (step S210). This status information is converted into serial status information by the IO interface circuit 21 and transferred to the host system 20 (step S211). Thus, the main controller 23 of the host system 20 acquires the status information indicating the result of execution performed in the HDD 10 in response to the read command that has been written to the register R₈ in the HDD 10 in accordance with the command-register write command. As described above, in the embodiment, the host system 20 can acquire the result of execution of a command in the HDD 10 in the same procedure as in the case where the host system 20 and HDD 10 are connected by a parallel interface (ATA interface).

After that, the main controller 23 generates a register control command (data-register read command) for reading data from the data register R₀ (step S118), and serial-transfers the data-register read command to the HDD 10 (step S119). As a result, the HDD 10 repeats the operation of reading read data from the data register R₀ and serial-transferring it to the host system 20 via the IO interface circuit 12, and the operation of writing the following read data to the data register R₀ (step S212). This repetition is continued until all data items requested by the host system 20 are transferred to the host system 20. Thus, in the embodiment, data transfer between the host system 20 and HDD 10 is performed by serial transfer by connecting the system 20 and HDD 10 by a serial interface, thereby realizing data transfer of a higher rate than in the case of connecting the host system and HDD by a parallel interface.

On the other hand, when the main controller 23 of the host system 20 receives all requested data items from the HDD 10 (step S120), it again generates an alternate-status-register read command (step S121). The alternate-status-register read command is converted into a serial register control command by the memory interface circuit 21 and transferred to the HDD 10 (step S122). As a result, in the HDD 10, status information is read from the alternate status register Rₘ₋₂ (step S213). The status information read from the register Rₘ₋₂ is sent to the host system 20 (step S214).

Referring to bits BSY and DRQ included in the status information sent from the HDD 10, the main controller 23 of the host system 20 determines whether BSY=0 and DRQ=0 (step S123). Until it is confirmed that BSY=0 and DRQ=0 (step S123), i.e., until all requested data items are transferred from the HDD 10, the main controller 23 repeats the above-mentioned step S121. Upon confirming that BSY=0 and DRQ=0, the main controller 23 generates a register control command (status-register read command) for again reading newest status information from the status register R₈ (step S124), and serial-transfers the generated command to the HDD 10 (step S125). The HDD 10, in turn, reads newest status information from the status register R₈ (step S215). The status information is converted into serial status information by the IO interface circuit 12 and transferred to the host system 20 (step S216). Thus, the main controller 23 of the host system 20 acquires status information indicating the result of final data reading by the HDD 10.

If an error bit ERR included in the status information indicates occurrence of an error (ERR=1), the main controller 23 of the host system 20 generates a register control command (error-register read command) for reading error information from the error register R₁ and transfers it to the HDD 10 via the memory interface circuit 21. The HDD 10, in turn, reads error information from the error register R₁, and sends the read information to the host system 20. Thus, the main controller 23 of the host system 20 can acquire error information indicating details of an error during execution of a command in the HDD 10, in the same procedure as in the case where the host system 20 and HDD 10 are connected by a parallel interface (ATA interface).

Re: (3) Writing of data to HDD 10:

The operation of the host system 20 to write data to the HDD 10 will be described briefly. Writing of data to the HDD 10 by the host system 20 is performed in the same procedure as in the case of reading data, i.e., in the same procedure as illustrated in the flowcharts of FIGS. 4A to 4C. Data writing differs from data reading in the process corresponding to step S118 in the flowchart of FIG. 4B. Specifically, at step S118, the host system 20 supplies the HDD 10 with a register control command (data-register read command) for reading (acquiring) data from the data register R₀. In contrast, in the case of data writing, the host system 20 supplies the HDD 10 with a register control command (data-register write command) for writing (transferring) data to the data register R₀ at the process corresponding to step S118. In this case, the host system 20 also supplies the HDD 10 with data (write data) of a size designated by the number of sectors set in the register R₂. The write data is stored in units of two bytes via the data register R₀ into a write buffer (not shown) provided in the main HDD unit 11 of the HDD 10. The write data stored in the write buffer is written to the disk 111a in units of sectors (e.g., in units of 512 bytes), starting at the position on the disk 111a designated by the target LBA [27-0] dispersively stored in the registers R₃, R₄, R₅ and R₆.

In the above-described embodiment, the present invention is applied to a system with a hard disk drive (HDD). However, the invention is also applicable to systems equipped with other disk drives such as magneto-optical disk drives. It is sufficient if the systems are provided with a disk drive that incorporates a disk control unit conforming to versatile parallel interfaces.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A disk drive used by a host system, the host system including a memory interface circuit which also serves as a serial interface circuit for connecting the host system to an input/output device conforming to a serial interface, the disk drive comprising:
a disk control unit conforming to a parallel interface and including a register file used to hold a command code and parameters, the register file including a plurality of registers equivalent to registers incorporated in an existing disk drive conforming to the parallel interface, the host system being accessible to the plurality of registers of the register file; and
an input/output interface circuit connected to the disk control unit via the parallel interface, and connectable to the memory interface circuit of the host system, the input/output interface circuit utilizing a protocol for the parallel interface to communicate with the disk control unit, and utilizing a protocol for the serial interface to communicate with the memory interface circuit of the host system,
and wherein the disk control unit includes a main controller which controls the registers of the register file in accordance with a series of register control commands and acquires a command code and parameters from the register file, when the host system sends the series of register control commands to the disk drive via the memory interface circuit of the host system, and the series of register control commands are transferred from the input/output interface circuit to the disk control unit, the command code and parameters being designated by the series of register control commands, the command code being to be executed in the disk drive, the parameters being necessary to execute the command code.

2. The disk drive according to claim 1, further comprising a device information register which holds device information unique to the disk drive, the host system being accessible to the device information register.

3. The disk drive according to claim 2, wherein a common particular address is assigned to the device information register, and to a similar device information register incorporated in each of input/output devices, regardless of types of the input/output devices.

4. The disk drive according to claim 3, wherein the input/output interface circuit supplies the memory interface circuit of the host system with device information held by the device information register, in reply to a device-information read command including the particular address, when the input/output interface circuit receives the device-information read command from the host system via the memory interface circuit of the host system, the device information register being designated by the particular address.

5. The disk drive according to claim 2, wherein an address is assigned to each of the registers of the register file, the address being represented by a common offset address and a relative address unique to said each register of the register file.

6. The disk drive according to claim 5, wherein the device information held by the device information register includes the offset address.

7. The disk drive according to claim 5, wherein the relative address assigned to said each register of the register file is identical to a relative address assigned to each of the registers of the existing disk drive conforming to the parallel interface.

8. The disk drive according to claim 1, wherein an address is assigned to each of the registers of the register file, the address being represented by a common offset address and a relative address unique to said each register of the register file.

9. The disk drive according to claim 8, wherein the relative address assigned to said each register of the register file is identical to a relative address assigned to each of the registers of the existing disk drive conforming to the parallel interface.

10. The disk drive according to claim 1, wherein the register file includes:
a status register which holds a command execution result including an error bit which indicates whether an error occurs; and
an error register which holds error information indicating details of the error.

11. An interface connecting method of connecting a disk drive to a host system equipped with a memory interface circuit, the memory interface circuit also serving as a serial interface circuit for connecting the host system to an input/output device conforming to a serial interface, the disk drive including a disk control unit conforming to a parallel interface, and an input/output interface circuit connected to the disk control unit via the parallel interface and connectable to the memory interface circuit of the host system, the input/output interface circuit utilizing a protocol for the parallel interface to communicate with the disk control unit, and utilizing a protocol for the serial interface to communicate with the memory interface circuit of the host system, the interface connecting method comprising:
generating a series of register control commands conforming to the parallel interface, by a main controller incorporated in the host system, when the main controller accesses the disk drive via the memory interface circuit;
transferring the series of register control commands to the disk drive by the memory interface circuit of the host system in accordance with a protocol for the serial interface;
performing, in accordance with the transferred series of register control commands, a register operation on a register file used to hold a command code and parameters, when the series of register control commands transferred to the disk drive is transmitted to the disk control unit by the input/output interface circuit of the disk drive in accordance with a protocol for the parallel interface, the register operation including writing a command code and parameters to the register file, the command code and parameters being designated by the series of register control commands, the command code being to be executed in the disk drive, the parameters being necessary to execute the command code, the register file including a plurality of registers equivalent to registers incorporated in an existing disk drive conforming to the parallel interface, the host system being accessible to the plurality of registers of the register file; and
executing the command code using the parameters, the command code and parameters being held in the register file.

12. The interface connecting method according to claim 11, wherein the disk drive includes a device information register which holds device information unique to the disk drive,
the interface connecting method further comprising:
reading the device information from the device information register by the main controller of the host system; and
determining a type of a device connected to the host system based on the device information read by the main controller of the host system, the determining including recognizing that the disk drive conforms to the parallel interface, when the device information indicates that the device connected to the host system is the disk drive.

13. The interface connecting method according to claim 12, wherein an address is assigned to each of the registers of the register file, the address being represented by a common offset address and a relative address unique to said each register of the register file.

14. The interface connecting method according to claim 13, wherein the device information held by the device information register includes the offset address.

15. The interface connecting method according to claim 13, wherein the relative address assigned to said each register of the register file is identical to a relative address assigned to each of the registers of the existing disk drive conforming to the parallel interface.
